(19) United States
(12) Patent Application Publication
(10) Pub. No.: US 2012/0228216 A1
(43) Pub. Date: Sep. 13, 2012

(54) FLOATING WATER TREATMENT DEVICE

(75) Inventors: Jonah GAVRIELI, Kiryat Tivon (IL); Pinhas Hascalovici, Haifa (IL); Emil Hascalovici, Haifa (IL)

(73) Assignee: J.P. AquaKnit Ltd, Haifa (IL)

(21) Appl. No.: 13/041,460

(22) Filed: Mar. 7, 2011

(51) Int. Cl. C02F 3/02

(52) U.S. Cl. 210/615; 210/150

(57) ABSTRACT

A floating water treatment device for biological treatment of water in a body of water, the device comprising: a submerged biomass-carrying system having at least one biomass-carrying element; a water aeration device adapted to aerate the water in the body of water in the vicinity of the biomass-carrying system; and at least one flotation system, having at least one floating element, the at least one flotation system adapted to float on the surface of the body of water and to support the submerged biomass-carrying system and water aeration device from totally submerging into the body of water.

### FIELD OF THE INVENTION

The present application relates to a floating water treatment device for the treatment of domestic, industrial and agricultural wastewater in ponds, pools and lagoons as well as biologically treating the water in aqua-culture farming facilities. The device comprises: a submerged biomass-carrier system, a water aeration device and at least one floatation system. The biomass-carrier system and the water aeration device are deployed in conjunction in the treatment of water while the flotation system keeps the water-treatment systems afloat. The biomass-carrier system and water aeration device are deployed in either a close association, with the system and device connected independently to flotation systems or the system and device both connected to a single flotation system.

### BACKGROUND OF THE INVENTION

The technology for the biological-removal of dissolved organic compounds and/or ammonia-compounds and/or nitrate-compounds from water by the stimulated growth of biomass is commonly referred to as “biological water treatment”.

In the specification and claims which follow hereinbelow, the term “to-be-treated water” is intended to mean the water that has yet to be treated by prior art systems and/or by embodiments of the current invention.

By establishing contact between to-be-treated water and a medium having a relative large and exposed surface area enhanced growth of surface-attached biomass is facilitated, thus improving treatment efficiency. The utilization of variety of large surface area media for biomass growing, commonly known as “biomass-carrying media”, in domestic, industrial and agricultural wastewater treatment technologies is well documented. The use of biomass-carrying media is also documented in the treatment of water in aqua-culture farming (the growing of fish, crustaceans, mollusks, and other water growing organisms). Removal of dissolved organic substances from water is substantially more efficient when the biomass metabolizes the organic substances in aerobic conditions. Aerobic conditions also facilitate biomass transformation of ammonia-compounds to nitrates in to-be-treated water. Transformation of ammonia-compounds to nitrates is also enhanced when biomass-carrying media is used in water treatment. Anoxic and/or anaerobic conditions in to-be-treated water facilitate biomass denitrification of nitrates to nitrogen. As in the biomass transformation of ammonia-compounds to nitrates, denitrification is enhanced when deploying biomass-carrying media in appropriate water treatment conditions.

Examples of biomass-carrying media include, but are not limited to: a single sheet of flexible fabric; a single plate of a rigid material; and a group of strings connected to a common supporting unit. These media are also referred to in the specification and claims which follow as “biomass-carrying element”. Various Biomass-carrying elements are collectively interchangeably referred to in the specification and claims which follow as “bio-carrier elements” or simply “bio-carriers”. Assemblies of bio-carrier elements that are deployed in a conjunctional formation are referred to in the specification and claims which follow as a “bio-carrier system” or as a “biomass-carrier system”.

Bio-carrier elements are fabricated in a range of categories such as, but not limited to fabrics of various materials that can be produced in various production technologies and which may be flexible, inflexible, and/or stretchable. The fabrics may have various spatial configurations and be proliferated or solid. Emphasis is placed hereinbelow on mono-filament knit fabric bio-carrier elements, as described in WO2009/004612 (Gavrieli et al.), which is incorporated herein by reference. Rigid materials sheet or plate structures may also be used as bio-carrier elements. These elements may be made of materials such as, but not limited to, PVC or metal. The rigid plates can be solid or proliferated, be in different geometrical configurations and have various spatial structural configurations such as, but not limited to, a corrugated structure. Various three dimensional structural configurations may also be utilized as bio-carrier elements. These elements may be made of rigid materials such as, but not limited to, PVC or metal, or soft materials such as sponges. Three dimensional structural configuration bio-carrier elements may have various spatial configurations such as, but not limited to, honeycomb blocks, and may be constructed of a plurality of connected units of fabrics and/or sheets, as previously described. Bio-carrier elements can also be produced from wire or string structures. Each string or wire structure element comprises a module connected to a common supporting unit such as a bar or a plate. The wires or strings may be flexible or rigid and they may be produced from various materials such as, but not limited to, plastic or metal, and they may have a range of spatial configurations such as, but not limited to, loops and bundles.

In the specification and claims which follow, the term “flotation element” is intended to mean one or more distinct buoyant structures that float on or near the surface of the water. Flotation elements can be structures made of wood, plastic of various types, polyurethane-foam, and other water buoyant material and they can be in any functional design. Containers filled with trapped-air or other types of gas or gasses can also serve as flotation elements. Assemblies of flotation elements that are deployed in a conjunctional formation are referred to in the text that follows as either a “flotation system” or a “floating device”.

Examples of the use of bio-carrier elements in bio-carrier systems utilized in water treatment processes are listed below.

DE 10,132,546 (Langendorf P.) describes the use of a textile material sheet in biological waste water treatment plants. US 2008/0093294 (Kulick et al.) describes a bio-carrying media made of corrugated sheets having crests and valleys positioned in assemblies that form biological treatment systems. JP 9,001,175 (Takeshita K.) describes suspending string-like bio-carriers. WO2009/004612 (Gavrieli et al.) describes the use of mono-filament knit-fabrics that are able to stretch and return to their relax state, as a biomass-carrier media.

Other terms as used in the specification and claims which follow are:
“aeration”, intended to mean one or more techniques of introducing dissolved gas into a liquid media. Aeration is typically meant to be the dissolving of oxygen into water.
“vicinity”, intended to mean a not rigidly defined distance from a given biomass-carrier system in which dissolved oxygen introduced to the water by aeration has a significant positive influence on the aerobic metabolism carried out by the biomass in the biomass-carrier system.
“close association”, intended to mean a not rigidly defined distance in which aeration or, alternatively, an agitation imparts a desirable effect on the biomass in a biomass-carrier system.

Aerobic metabolically active microorganisms in the biological treatment of bodies of water such as in pools in activated-sludge facilities, lagoons, wastewater oxidation ponds, and pools is achieved by aeration devices. Aeration of large bodies of water is also of major importance in aqua-culture farming of oxygen consuming organisms that are typically grown in ponds and pools.

A common method of aeration is the introduction of bubbles of air and/or oxygen by gas diffusers. Single diffusers structure units, referred to hereinbelow as “gas diffuser elements” or interchangeably as “diffuser elements” can be produced from a variety of materials and can be in disk or/and pipe construction-form. When an assembly of aeration elements is deployed in a conjunctional formation it is referred to hereinbelow as a “diffuser device”.

Alternatively, aeration can be achieved by the vigorous mixing or stirring to-be-treated water with ambient air and/or oxygen by devices having elements such as: various propeller-like configurations (including rotating-screw configurations), paddle wheels, air-pumps and water-air jet mixer of various configurations. Such devices are referred to in the specification and claims which follow as “aeration devices”.

Biomass metabolic denitrification transformations require anaerobic or anoxic conditions. Propellers, paddles and other water-mixers and stirrers are deployed in a configuration and manner that cause minimal whirlpools and breaking waves on the surface of the water body to effect mixing and stirring of treated water while loading the water with minimal concentrations of dissolved oxygen. When deployed in such a configuration, aeration devices are referred to in the specification and claims which follow as “water agitation devices”.

Diffuser elements are produced in various shapes and sizes. Diffuser elements produce bubbles ranging from coarse to fine bubbles. The placement of diffuser devices can be at the bottom of the body of water, where they are either loose or fixed-in-place to the bottom or side of the body of water and fed compressed air and/or oxygen supplied by a feed-pipe. Alternatively, diffuser devices can be suspended in the water by being connected to floatation devices and have compressed air and/or oxygen fed to them from a connected gas feed pipe. In submerged diffuser devices as well as in diffuser devices connected to floatation devices the compressed air and/or oxygen supplied via a feed pipe to the diffuser devices originates from air-compressing devices (an air-compressor, an air-blower, an air-pump or any other air-compressing device) positioned on dry land. Alternatively, compressed air and/or oxygen can be supplied to a diffuser device via an air leading-pipe from a compressor or a blower positioned on a floating platform separated from the diffuser device.

Alternatively or optionally, in diffuser devices suspended in to-be-treated water by being connected to floatation devices, compressed air and/or oxygen is supplied by an air-compressing device (an air-compressor, an air-blower, an air-pump or any other air-compressing device) that is connected to the flotation system that keeps the diffuser device suspended in the water.

Examples of floating-diffusers devices are listed hereinbelow.

The FBC Technologies Inc. Company (57 North Street, LeRoy, N.Y. 14482, USA. Web-site: www.fbctech.com/octopus.htm) produces the “Octopus Floating Fine Bubble Aeration System” which is a surface-maintainable aeration system. Each aeration unit in the system comprises 8 membrane diffusers connected to the bottom of 8 perpendicular legs which are connected at the top to a round manifold which is connected to a floating air supply pipe. The number of aeration units can vary in accordance to the aeration requirements. GB 2,431,598 (Inventors: Trentadue et al., Applicant: Smith & Loveless Inc.) describes an apparatus for introducing a gas into a body of a liquid. The apparatus comprises a horizontal frame on ballast adjustable floats connected to a vertical shaft. The shaft has a plurality of radial-extending blades and is submerged in the liquid. A membrane diffuser is connected to each blade and the diffusers are supplied with compressed air that is supplied through the shaft. WO 2009/053975 (Magen H. et al.) describes an aeration device for the introduction of gas bubbles into liquid medium. The device comprises a flotation element (“member” in the original text) through which an elongated tube in inserted. The bottom side of the inserted tube is submerged in the liquid and has at its end a distribution hub from which pipes radiate. At the end of each of the pipes a diffuser aeration member is connected. The inserted pipe is connected to a source of compressed air that is fed to the diffuser aeration members. The depth of submergence of the distribution hub can be varied in accordance to the level of the liquid by sliding the inserted pipe through the flotation element. Both GB 2,431,598 and WO 2009/053975 describe devices that can be deployed in a plurality of units, depending on the aeration requirements. Each of the units can be deployed independently or in tandem with other units.

Examples of floating aeration devices that achieve the aeration in water treatment processes by vigorous mixing or stiffing are listed below.

The MAOFMADAN Company (of Kibbutz Maagan Michael 37805, Israel. Web-site: www.maofmadan.com) produces paddlewheel aerator devices in various configuration. In the configurations a plurality of partially water-submerged paddlewheels are mounted on the same horizontal bar. A motor rotates the bar thus, simultaneously turning the paddle wheels. The motor and paddlewheels are kept afloat above the surface of the water by being connected to floatation elements. The mixing and stirring of the surface-water by the paddlewheels mixes ambient air into the water and by so dissolves oxygen into the water in the vicinity of an operating device.

The AEROMIX Company (of 7135 Madison Avenue West, Minneapolis, Minn. 55427-3601, USA. Web-site: aeromix.com) produces a range of sub-surface, floating and self-contained, aerator devices that deliver dissolved oxygen into a wide range of wastewater treatment processes in lagoons and oxidation ditches. The company's devices are based on a submerged propeller connected to flotation elements. The propeller is rotated in the water by a motor connected to the driving shaft of the propeller and is positioned above the water. The vigorous stirring of the water by the rapid rotation of the propeller mixes ambient air into the water and by so dissolves oxygen into the water. The aerated water is produced by the aeration device in the vicinity of the biomass-carrier system.

The AQUASYSTEMS INTERNATION n.v. Company (of Brusselsesteenweg 508, B-1500 Halle, Belgium. Web site: http://www.aquaturbo.be) produces a wide range of water aeration and mixing devices based on propellers, rotating screw-configuration devices as well as diffuser devices. Some of the company's devices are deployed when submerged to the bottom of the to-be-treated water body; other devices are deployed from the surface of the to-be-treated water while floating on flotation systems.

It is an object of embodiments of the present invention to substantially advance the treatment technology of wastewater and aqua-culture farming water by introducing a water treatment device that comprises a biomass-carrier system, an aeration device and a floatation system. The biomass-carrier system and the aeration device are deployed in conjunction with the system and device connected together to a single flotation system. Alternatively, the bio-carrier system and the aeration device are deployed in conjunction and the system and device are individually connected to closely associated flotation systems.

### SUMMARY OF THE INVENTION

According to the teachings of the present invention there is provided a floating water treatment device for biological treatment of water in a body of water, the device comprising: a submerged biomass-carrying system having at least one biomass-carrying element; a water aeration device adapted to aerate the water in the body of water in the vicinity of the biomass-carrying system; and at least one flotation system, having at least one floating element, the at least one flotation system adapted to float on the surface of the body of water and to support the submerged biomass-carrying system and water aeration device from totally submerging into the body of water. Preferably, the biomass-carrying system and the aeration device are connectable to the same flotation system. Most preferably, the biomass-carrying system and aeration device are connectable to separate flotation systems. Typically, the separate flotation systems are adapted to be reversibly connected by a mechanical connection fixture. Most typically, at least one of the biomass-carrying elements has a sheet structure.

Preferably at least one of the biomass-carrying elements has a corrugated sheet structure. Most preferably, at least one of the biomass-carrying elements is made of fabrics. Typically, at least one of the biomass-carrying elements is made of mono-filament knit fabric. Most typically, at least one of the biomass-carrying elements has a string structure. Typically, the aeration device has gas diffuser elements. Most typically, the gas diffuser elements are fed with air from a compressed air source. Preferably, the water aeration device has at least one paddle wheel adapted to stir and mix the water. Most preferably, the aeration device is at least one partly-submerged propeller-like configuration device. Typically, the aeration device is at least one water-air jet mixer configuration device. Most typically, the aeration device is an agitation device.

According to the teachings of the present invention there is further provided method of using a floating device for biological treatment of a water body comprising the steps of: deploying a submerged biomass-carrying system having at least one biomass-carrying element; utilizing a water agitation device to agitate the water in the water body in the vicinity of the biomass-carrying system; floating at least one flotation system, having at least one floating element, on the surface of the body of water and supporting the submerged biomass-carrying system and water aeration device from totally submerging into the body of water. Preferably, the biomass-carrying system and the aeration device are connected to the same flotation system. Most preferably, the biomass-carrying system and aeration device are connected to separate flotation systems. Typically, the separate flotation systems are reversibly connected by a mechanical connection fixture. Most typically, the aeration device is an agitation device.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Components which are substantially the same in structure and functionality are denoted by the same reference numerals throughout.

FIG. 1 is a side view of a water treatment device shown floating on a to-be-treated body of water with a diffuser aeration device shown bubbling air in the vicinity of the biomass-carrying system of the water treatment device, in accordance with an embodiment of the present invention.

FIG. 2 is an isometric and a partially cross sectional view of the floating water treatment device in which diffuser aeration elements are shown bubbling air bubbles between the sheet-form bio-carrier elements of the water treatment device, in accordance with an embodiment of the present invention.

FIG. 3 is an isometric view of a paddle wheel aeration device stirring and mixings water in the vicinity of sheet-form bio-carrier elements of the water treatment device, in accordance with an embodiment of the present invention.

FIG. 4 is an isometric and a partially cross sectional view of a propeller aeration device positioned beneath the sheet-form bio-carrier elements of the water treatment device, in accordance with an embodiment of the present invention.

FIG. 5a is an isometric view of aeration elements discharging air bubbles between mono-filament (stretching-relaxing) knit-fabric bio-carrier elements of the water treatment device. Compressed air for the bubbling is obtained via a gas feed pipe connected to the water treatment device, in accordance with an embodiment of the present invention.

FIG. 5b is an isometric view of a variant of the aeration elements shown in FIG. 5a, in which the compressed air for the bubbling is generated by an air blower positioned on the water treatment device, in accordance with an embodiment of the present invention.

FIG. 6 is an isometric detailed view of a section of FIG. 5a explaining the modus operandi of the stretching-relaxing of the mono-filament knit-fabric bio-carrier elements in a floating water treatment device, in accordance with an embodiment of the present invention.

FIG. 7 is a side view of the water treatment device floating on a to-be-treated body of water. The shown propeller aeration device and a biomass-carrying system each have separate floatation devices that are closely associated, in accordance with an embodiment of the present invention.

FIG. 8 is a side view of the water treatment device floating on a to-be-treated body of water. The shown diffuser aeration device and a biomass-carrying system each have separate floatation devices that are closely associated, in accordance with an embodiment of the present invention.

### DETAILED DESCRIPTION OF PREFERRED EMBODIMENTS

An object of embodiments of the present invention is to substantially improve the treating of domestic, industrial and agricultural wastewater as well as aqua-culture farming water stored in large bodies of water such as lagoons and ponds. The water treatment device in accordance with embodiments of the present invention comprises a surface-floating and submerged floating biomass-carrier system, kept afloat by a flotation system, and an aeration device, deployed in close association to the biomass carrier system and kept afloat by a flotation system. The biomass-carrier system and water aeration device are either in close association where the biomass-carrier system and water aeration device each float independently with its own flotation system or, alternatively, in close association where the biomass-carrier system and water aeration device are connected to each other, thus, floating with the aid of a single flotation system and forming a self contained water treatment device.

Dissolved oxygen-containing (aerated) water, which contains dissolved organic compounds, comes into contact with the biomass carrier elements and enables the continual development of the biomass in the biomass carrying system. In aerobic conditions, imparted by the aeration device, the biomass in the biomass-carrier system may also transform ammonia compounds into nitrates.

When a water aeration device in accordance with embodiments of the present invention is deployed as a water agitation device in the vicinity of the biomass carrying system, the set-in-motion water comes into contact with the biomass carrying system. In the anoxic and or anaerobic water environment the biomass in the biomass carrying system metabolizes water dissolved organic substances in anaerobic metabolism and transforms nitrate compounds to nitrogen.

The biological aerobic transformation of ammonia compounds to nitrate compounds and the biological anaerobic transformation of nitrate compounds to nitrogen are of especial significance in the treatment of water in aqua-culture farming facilities.

The water treatment device in accordance with embodiments of the present invention is simple to deploy and simple to remove from a water location for maintenance and redeployment. The positioning and removal of the water treatment device to and from the body of water can be carried out by the use of a mobile-crane. The choice of the number water treatment device units to be deployed and the location of the units in the treatment of a given body of water will vary in accordance with treatment requirements. The floating water treatment device, in accordance with embodiments of the present invention, can be secured to remain in a desired location-position in a given body of water by connecting the device to an anchor or anchors.

In order to deploy the water treatment device, in accordance with embodiments of the present invention, no infrastructure in the body of the water to-be-treated is required. For deployment of the water treatment device only an electricity supply source is required. In alternative configurations of the water treatment device, a supply of compressed air is required. In yet other alternative configuration, both an electricity source and a compressed-air supply are required. Typically, electricity is supplied by an electricity cable that stretches from the water treatment device(s) to an electricity distribution source on the bank of the water body.

In a water treatment device, in accordance with embodiments of the present invention, where the aeration device comprises diffuser elements, compressed air for the diffusers is generated by either an air-blower or an air compressor that is an integral part of the aeration device and is part of the structure of the water treatment device. Alternatively, when the aeration device comprises diffuser elements and the aeration device does not include an air-blower or an air compressor, compressed air is supplied to the diffuser elements via a gas feed line (supplying air/or oxygen) that may float on the water, as described in WO 2009/053975 (Magen H. et al.). If a given bio-carrier system deployed in a given water treatment device does not require electricity for functioning, and compressed air for the aeration device is supplied via a gas feed line, than no electricity source is required to be connected to the operating water treatment device.

The choice of the bio-carrier elements, their construction material and their formation-shape as well as the spatial configuration in which they are positioned in the bio-carrier system which is deployed in the water treatment device is an integration of choices from a large number of possible configurations. The figures illustrating preferred embodiments of the water treatment device in accordance with the present invention present sheet-like rigid-material structure biomass carriers. The figures illustrate a few examples of many possible bio-carrier system configurations.

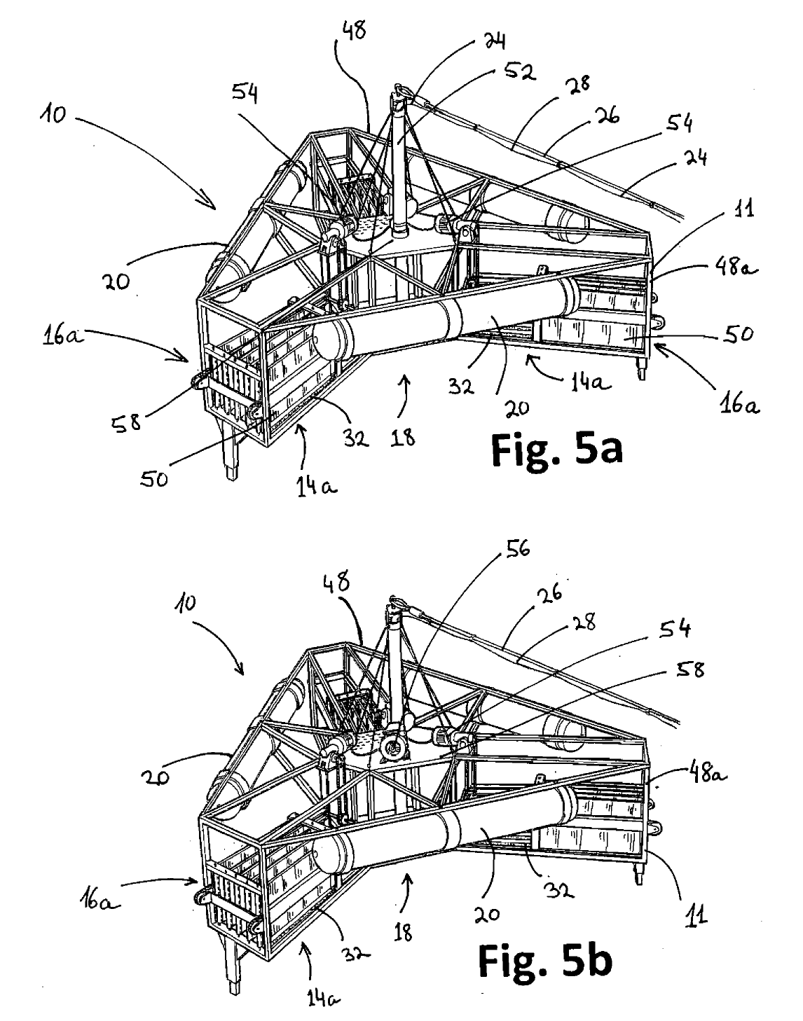

FIG. 5a and FIG. 5b illustrates preferred embodiments of the present invention in which the bio-carrier system comprises mono-filament knit fabric sheets in accordance to the description given in WO2009/004612 (Gavrieli et al.). In the course of the treatment of water the knit-fabric sheets are mechanically stretched and relaxed, causing the removal of excess biomass that forms on the knit-fabrics to the surrounding water. The removal of the excess biomass enables the biomass that remains on the knit fabrics to continue to proliferate rapidly on the surfaces that were cleared by the stretching-relaxing movements. The mechanism for stretching and relaxing of the knit-fabrics, done via the motion of pneumatic or hydraulic pistons or directly by a motor via mechanical gears, is integrated into the biomass carrier system in the water treatment device. When operating of pneumatic pistons for the stretching-relaxing, deployment of the pistons can be obtained by the feeding of compressed air to the pistons via a pipe that runs from a compressed air source on the bank of the water body to the pistons on the water treatment device.

Each of the different water aeration devices (previously described hereinabove) when integrated into a water treatment device in accordance with the present invention, can be in a variety of mechanical configurations. The configuration of an aeration device of choice deployed in a given water treatment device “supplies” to-be-treated water “loaded” with dissolved oxygen together with dissolved organic compounds and/or ammonia-containing compounds to the biomass in the bio-carrier system in the device. Alternatively, when an aeration device is deployed as a water agitation device, water with low oxygen concentration and “loaded” with dissolved organic compounds and/or nitrate-containing compounds is supplied to the biomass in the bio-carrier system.

The mechanical configuration of a biomass-carrier system, the aeration device, and the flotation system deployed in a given water treatment device, in accordance with the present invention, are chosen from a large selection of possible mechanical configurations of systems.

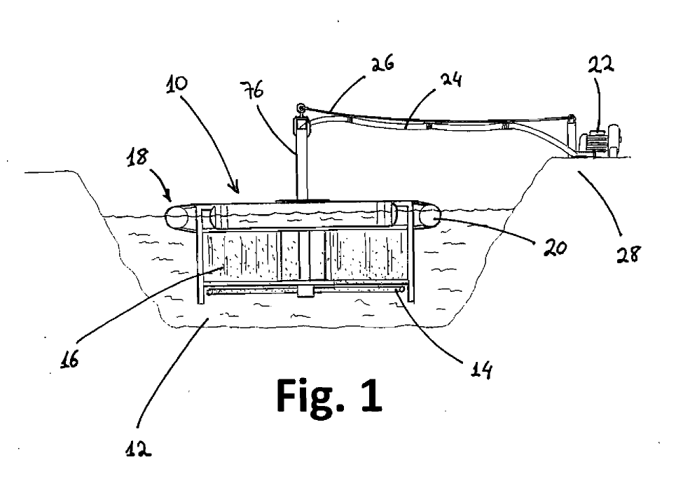

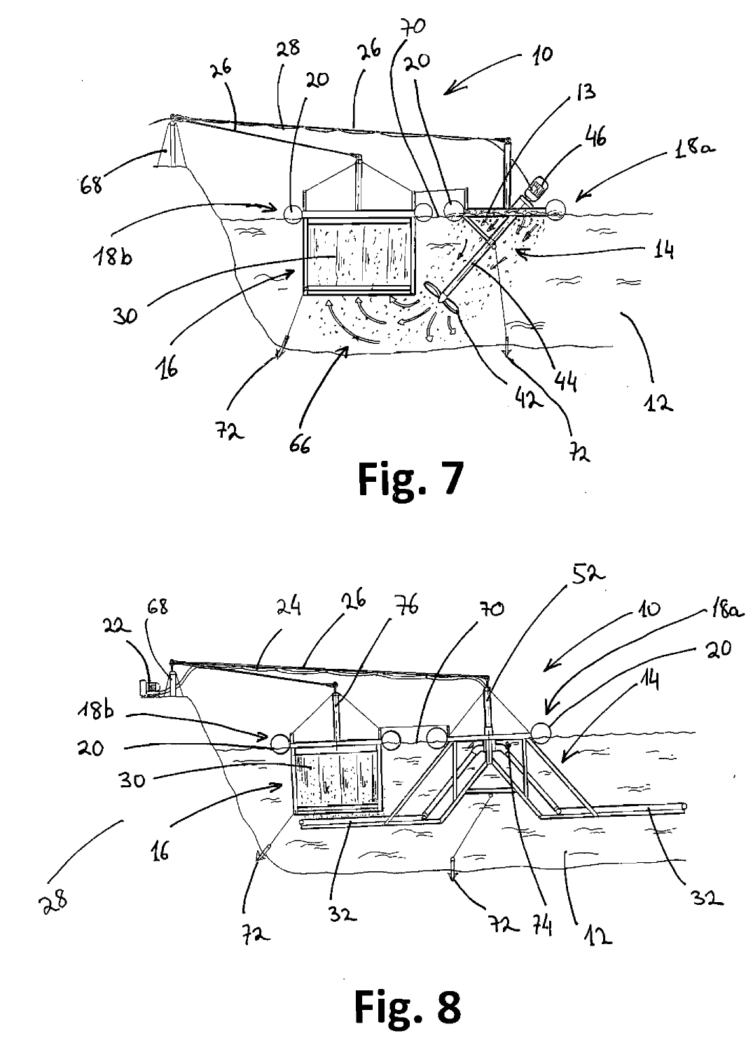

The figures are divided into embodiments of the current invention in which the biomass carrier system and the aeration device are in close association and are connected (FIG. 1 to FIG. 6) and where the biomass carrier system and the aeration device are in close association but are not connected physically by a common floatation system. While not being connected physically by a common floatation system, the biomass carrier system and the aeration device may, in other embodiments, be connected by a connection that is either a fix-in-place, “permanent” mechanical connection-fixtures or, alternatively, a reversibly connected mechanical connection-fixture that is simple to connect and disconnect (FIG. 7 and FIG. 8):

FIG. 1 shows a general side view of a water treatment device 10 in accordance with an embodiment of the present invention. The water treatment device floats on a to-be-treated body of water 12 with a diffuser aeration device 14 bubbling air in the vicinity of the biomass-carrying system 16 of the water treatment device. Water treatment device 10 is floats with the aid of a floatation system 18 comprising cylinder-shaped floating elements 20. Aeration device 14 is fed with compressed air generated by an air-blower 22. Compressed air is delivered to aeration device 14 via a tube 24 which is fixed in its position by a cable 26 extending between the water treatment device 10 and the dry bank 28 surrounding the body of water 12. Cable 26 is shown connected to stabilizing pole 76 through which tube 24 reaches aeration device 14.

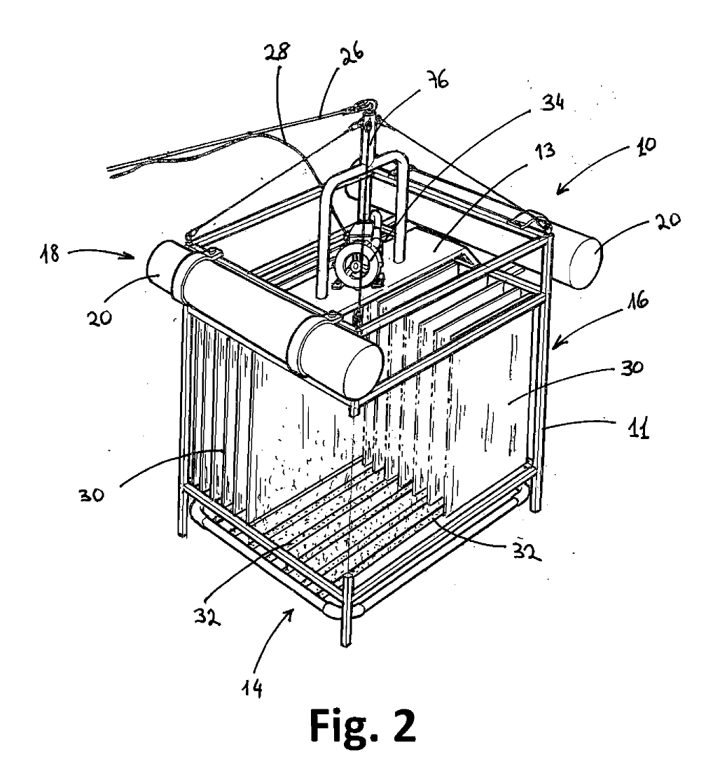

FIG. 2 shows an isometric and a partially cross sectional view of floating water treatment device 10 in, accordance with an embodiment of the present invention. The water treatment device 10 shown in the figure comprises: an aeration device 14 constructed of diffuser elements 32, a bio-carrier system 16 constructed of sheet-form bio-carrying elements 30 and a floatation system 18 comprising cylinder-shaped floating elements 20. The aeration device 14, the bio-carrier system 16 and the floatation system 18 are connected and fixed in place to a structural-frame 11. Diffuser aeration elements 32 are shown bubbling air bubbles between the sheet-form bio-carrier elements 30 of the water treatment device. In traveling vertically between the bio-carrier elements, the bubbles form an air-lift effect that causes turbulence in the water, thus, the bubbles enrich the water with dissolved oxygen and drive the to-be-treated water to contact with the bio-carrier elements. Compressed air is supplied to diffuser elements 32 by an air-blower 34, positioned on the upper section (that is not submerged) of structural-frame 11 of water treatment device 10 on platform 13. From platform 13 extends stabilizing pole 76. An electricity cord 28 supplies the electrical power to air-blower 34 from an electricity source external to water treatment device 10. Cable 26 which, extends between and an anchoring position (not shown) on the bank of the water body stabilizes treatment device 10 in the water and (also) supports electricity cord 28. Cylinder-shaped floating elements 20 are connected to the upper section of structural-frame 11.

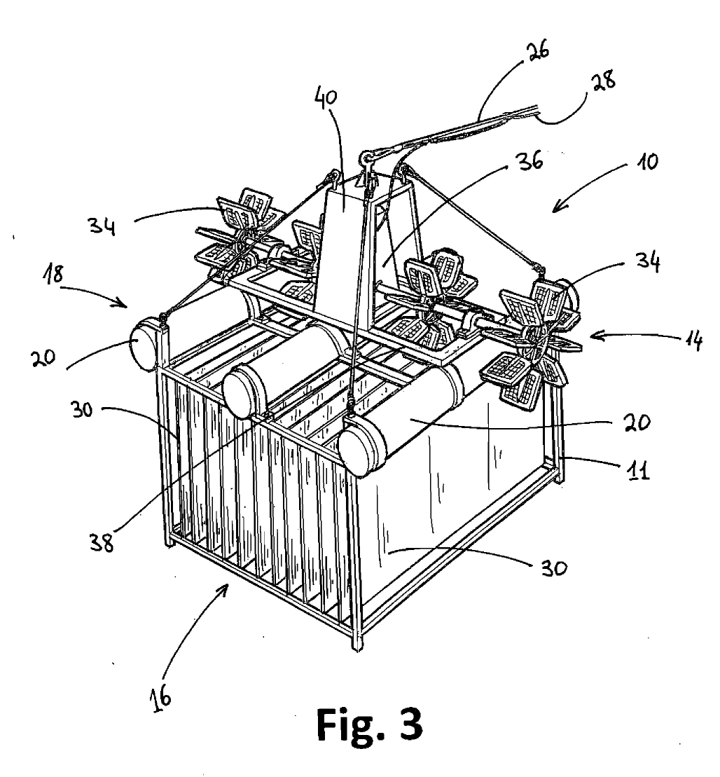

FIG. 3 is an isometric view of another embodiment of the floating water treatment device 10, in accordance with an embodiment of the present invention. Water treatment device 10 comprises: an aeration device 14 constructed of paddle wheels 34, a bio-carrier system 16 constructed of sheet-form bio-carrying elements 30 and a floatation system 18, comprising cylinder-shaped floating elements 20. The aeration device 14, the bio-carrier system 16 and the floatation system 18 are connected and fixed-in-place to a structural-frame 11. An electrical gear-motor 36 rotates paddle wheels 34 and is fixed-in-position on bridge 38. Bridge 38 is fixed-in-position to floating elements 20. Protective cover structure 40 is (also) fixed-in-place on bridge 38 and protects motor 36 from the environment. In rotating, paddle wheels 34 cause turbulence in the water and by so dissolve oxygen in the water as well as guide oxygen enriched to-be-treated water towards the bio-carrier elements. Cable 26 stabilizes treatment device 10 in the water and has electricity cord 28 connected to it. Cable 26 extends between water treatment device 10 and an anchoring position (not shown) on the bank of the water body. Cylinder-shaped floating elements 20 are connected to the upper section of structural-frame 11.

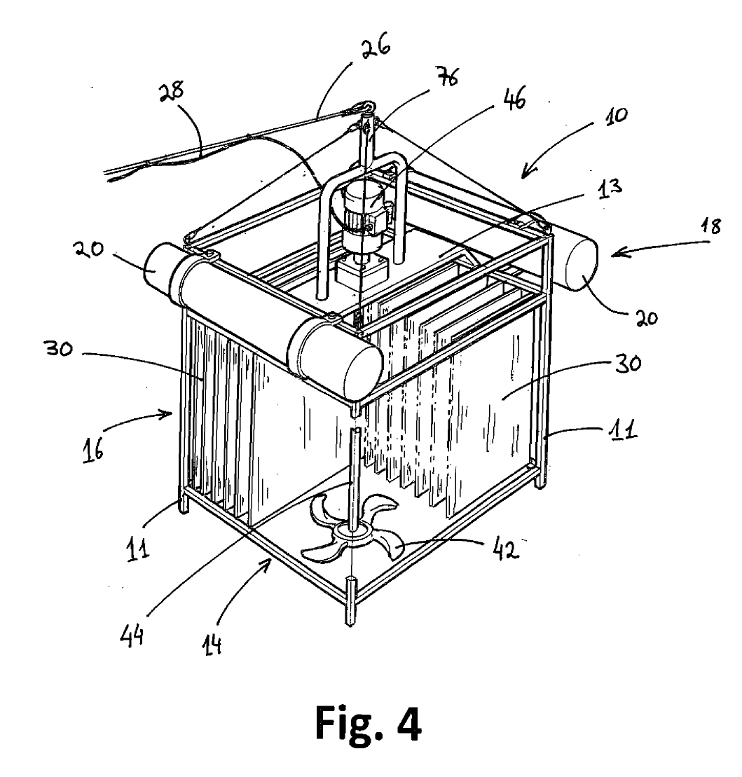

FIG. 4 is an isometric and a partially cross sectional view of the floating water treatment device, in accordance with another embodiment of the present invention. Water treatment device 10 comprises: an aeration device 14 constructed of propeller 42, a bio-carrier system 16, constructed of sheet-form bio-carrying elements 30 and a floatation system 18, comprising cylinder-shaped floating elements 20. Aeration device 14, bio-carrier system 16 and floatation system 18 are connected and fixed-in-place to a structural-frame 11. Propeller 42 is rotated by a shaft 44, driven by an electric motor 46, positioned and fixed-in-place on the upper section of partially submerged structural-frame 1, on platform 13. Propeller 42 is rotated, preferably in the direction that steers water from the surface of the body of the water towards the propeller, at rotational speed that causes oxygen enriched water to stream through the spaces between bio-carrier elements 30. Alternatively, propeller 46 (serving as an “agitation device”) is rotated, preferably in the direction that the water is directed upwards, towards the surface of the water body, at a rotational speed that steers water with relatively small concentrations of dissolved oxygen to stream through the spaces between bio-carrier elements 30. In water “loaded” with dissolved organic compounds and nitrate-compounds and with relatively low oxygen concentration, the environmental conditions surrounding the biomass-carrying elements become anoxic or anaerobic and denitrification takes place. Cable 26 stabilizes treatment device 10 in the water and supports electricity cord 28. Cable 26 extends between stabilizing pole 76 that extends from platform 13 and an anchoring position (not shown) on the bank of the water body. Cylinder-shaped floating elements 20 are connected to the upper section of structural-frame 11.

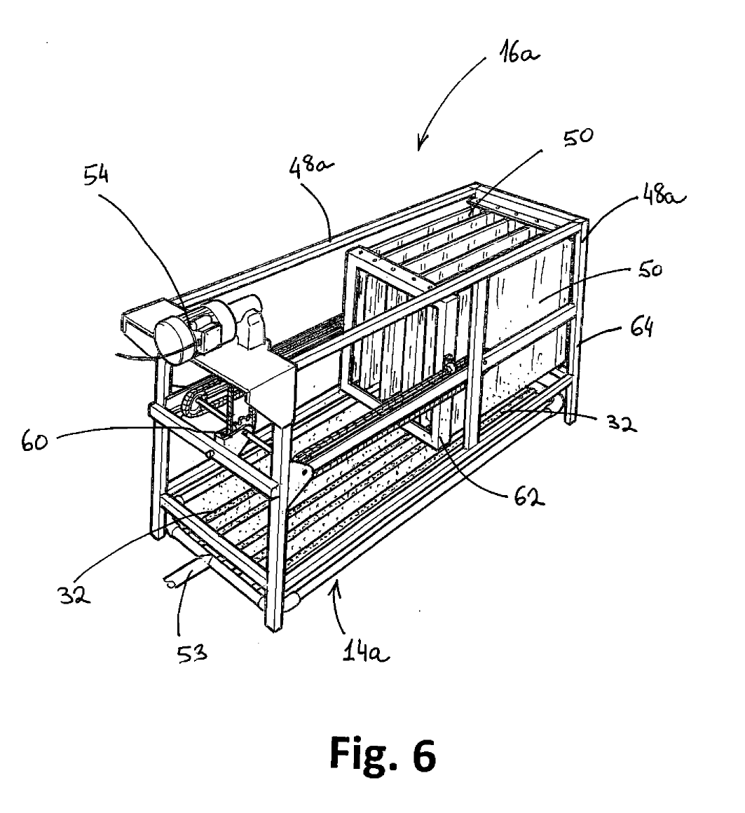

FIG. 5a is an isometric view of yet another embodiment of the floating water treatment device 10, in accordance with an embodiment of the present invention. Water treatment device 10 comprises: a structural-frame 48 to which a floatation system 18, comprising cylinder-shaped floating elements 20 are connected and fixed-in-place. In addition, device 10 comprises a bio-carrier system 16 sub-divided to three independent units, each sub-bio-carrier-system unit is numbered in the figure as 16a. The floating water treatment device 10 in the figure also comprises an aeration device 14 which is sub-divided to three independent units; each sub-aeration-device unit is numbered in the figure as 14a. Sub-bio-carrier-system units 16a, sub-aeration-device units 14a and floatation system 18 are connected and fixed-in-place to structural-frame 48. Each sub-bio-carrier-system units 16a comprises an assembly of mono-filament knit fabric sheets 50 that are positioned in parallel, as described in WO2009/004612 (Gavrieli et al.). A unit of sub-aeration-device 14a is fixed-in-place under each unit of bio-carrier-system 16a. Each unit of sub-aeration-device 14a comprises diffuser elements 32. Compressed air is provided to each of the sub-aeration-devices 14a from a central-distribution air pipe 52 that obtains compressed air from an air-compressor or an air-blower (not shown). Each sub-bio-carrier-system units 16a and sub-aeration-device 14a are positioned and fixed-in-place to structural-frame 48a (see FIG. 6 for elaboration). The compressed air is delivered to air pipe 52 (of which only an external, protective tube shown) via a tube 24 which is fixed-in-its-position to a cable 26, extending between water treatment device 10 and the dry bank surrounding the body of water (not shown), as illustrated in FIG. 1. Cable 26 also supports electricity supplying cable 28. Electricity is provided via cable 28 to the electrical gear motors 54 that operate in stretching and relaxing the assembly of mono-filament knit fabric sheets 50 in each sub-bio-carrier-system units 16a. FIG. 6 explains in detail the modus operandi of sub-bio-carrier-system units 16a in conjunction with sub-aeration-devices 14a. Cable 26 extends between water treatment device 10 and an anchoring position (not shown) on the bank of the water body and serves to stabilize treatment device 10 in the water.

FIG. 5b is an isometric view of a variant of the embodiment of the floating water treatment device 10 shown in FIG. 5a. In the embodiment compressed air for the bubbling sub-aeration-devices 14a is generated by an air blower 56 positioned on platform 50 positioned at the upper and central section of structural-frame 11 in water treatment device 10 and is distributed via a central-distribution air pipe (not shown). Cable 26 supports electricity supplying cable 28, with no need for a compressed air feed-pipe.

FIG. 6 is an isometric detailed view of a section of FIG. 5a and FIG. 5b. FIG. 6 shows a single sub-bio-carrier-system unit 16a comprising an assembly of mono-filament knit fabric sheets 50 positioned in parallel. FIG. 5a and FIG. 5b are shown with each water treatment device comprising three sub-bio-carrier-system units 16a. Positioned beneath sub-bio-carrier-system unit 16a is sub-aeration-device 14a which comprises of diffuser elements 32. Sub-aeration-device 14a if fed with compressed air through pip 53 that obtains air from pipe 52 shown in FIG. 5a. Diffuser elements 32 discharge air bubbles and/or oxygen between knit fabric sheets 50. Electric motor 54, via a gear and chains system 60, pulls frame 62 axially. In moving, frame 62 stretches mono-filament knit fabric sheets 50 which are connected on one side to frame 62 and on the other side to frame 64. Frame 64 is part of structural-frame 48a (see FIG. 5a for a broad view of the position of 48a within frames 48). Following the pulling movement, motor 54 via gear and chains system 60, moves frame 62 in the direction of frame 64, thus relaxing the stretched mono-filament knit fabric sheets 50. By repeated stretching and relaxing some of the biomass that builds on the knit fabric sheets 50 is removed to the surrounding water, enabling renewed biomass development on the surfaces cleared from excess biomass. The stretching-relaxing movements are timed to occur by a programmed logic controller (PLC, not shown in the Fig.) that controls motor 54. The stretching-relaxing timing is set in accordance with the development of biomass on knit fabric sheets 50.

FIG. 7 shows a side view of water treatment device 10 floating on a to-be-treated body of water 12, in accordance with an embodiment of the present invention. The device comprises a propeller aeration device 14 and a biomass-carrying system 16, each having a separate floatation system. The two flotation systems are designated 16a and 16b, respectively. Bio-carrier system 16 is constructed of sheet-form bio-carrying elements 30 and connected to floatation system 18b, comprising cylinder-shaped floating elements 20. Propeller aeration device 14 is connected to floatation system 18a, comprising cylinder-shaped floating elements 20. Propeller 42 is rotated by a shaft 44, driven by an electric motor 46, positioned and fixed-in-place on partially submerged structural-frame 13. Propeller 42 is rotated in the direction that steers water from the surface of the body of the water towards the propeller, at rotational speed that causes oxygen enriched water to stream through the spaces between bio-carrier elements 30. The stream of water with air bubbles is indicated by flow-arrows, numbered collectively 66. Two cables 26 stabilize treatment device 10 in the water by being connected to an anchoring position 68 on the bank of the water body. One of two cables 26 supports electricity cord 28 that extends between motor 46 and an electricity source on the bank of water body 12. Flotation systems 18a and 18b are closely associated and are connected together by either a fixed-in-place, connection-fixtures 70, or alternatively, by reversibly connected connection-fixtures 70 that can be easily connected and disconnected at will. Flotation systems 18a and 18b are shown anchored by anchors 72 to the bottom of water body 12

FIG. 8 shows a side view of water treatment device 10 floating on a to-be-treated body of water 12, in accordance with another embodiment of the present invention. The device comprises: an aeration device 14 constructed of diffuser elements 32, a bio-carrier system 16 constructed of sheet-form bio-carrying elements 30 and two floatation systems, designated 18a and 18b. The floatation systems comprises cylinder-shaped floating elements 20. Aeration device 14 is kept afloat by being connected to floatation system 18a. Submerged biomass-carrying system 16 is kept afloat by being connected to flotation system 18b. Flotation systems 18a and 18b are closely associated and are connected together by either a fixed-in-place connection-fixtures 70, or alternatively, by reversibly connected connection fixtures 70 that can be easily connected and disconnected, at will. Flotation systems 18a and 18b are shown anchored by anchors 72 to the bottom of water body 12. The two cables 26 stabilize treatment device 10 in the water by being connected to an anchoring position 68 on the bank of the water body. One of two cables 26 supports air tube 24 which extends between aeration device 14 and an air-blower or air compressor 22, positioned on dry land and supplies aeration device 14 with compressed air. The second cable 26 is shown connected to stabilizing pole 76 in the biomass-carrier system 16. Aeration device 14 is shown with two branched sets of diffuser elements 32 extending from a central-distribution air pipe 52. Taps 74 enables the shutting and regulating the flow of air through diffuser elements 32. Biomass-carrier system 16 is deployed in conjunction with aeration device 14, having air bubbles from diffuser elements 32 that are positioned below the biomass-carrier system 16 rise towards the surface of the water through the gaps between sheet-form bio-carrying elements 30. When the two branched sets of diffuser elements are deployed aeration device 14 can supply aeration simultaneously to two biomass-carrier systems.

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

1. A floating water treatment device for biological treatment of water in a body of water, the device comprising:
a submerged biomass-carrying system having at least one biomass-carrying element;
a water aeration device adapted to aerate the water in the body of water in the vicinity of the biomass-carrying system; and
at least one flotation system, having at least one floating element, the at least one flotation system adapted to float on the surface of the body of water and to support the submerged biomass-carrying system and water aeration device from totally submerging into the body of water.

2. The floating water treatment device of claim 1, wherein the biomass-carrying system and the aeration device are connectable to the same flotation system.

3. The floating water treatment device of claim 1, wherein the biomass-carrying system and aeration device are connectable to separate flotation systems.

4. The floating water treatment device of claim 3, wherein the separate flotation systems are adapted to be reversibly connected by a mechanical connection fixture.

5. The floating water treatment device of claim 1, wherein at least one of the biomass-carrying elements has a sheet structure.

6. The floating water treatment device of claim 6, wherein at least one of the biomass-carrying elements has a corrugated sheet structure.

7. The floating water treatment device of claim 6, wherein at least one of the biomass-carrying elements is made of fabrics.

8. The floating water treatment device of claim 7, wherein at least one of the biomass-carrying elements is made of mono-filament knit fabric.

9. The floating water treatment device of claim 8, wherein at least one of the biomass-carrying elements has a string structure.

10. The floating water treatment device of claim 1, wherein the aeration device has gas diffuser elements.

11. The floating water treatment device of claim 10, wherein the gas diffuser elements are fed with air from a compressed air source.

12. The floating water treatment device of claim 1, wherein the water aeration device has at least one paddle wheel adapted to stir and mix the water.

13. The floating water treatment device of claim 1, wherein the aeration device is at least one partly-submerged propeller-like configuration device.

14. The floating water treatment device of claim 1, wherein the aeration device is at least one water-air jet mixer configuration device.

15. The floating water treatment device of claim 1, wherein the aeration device is an agitation device.

16. A method of using a floating device for biological treatment of a water body comprising the steps of:
deploying a submerged biomass-carrying system having at least one biomass-carrying element;
utilizing a water agitation device to agitate the water in the water body in the vicinity of the biomass-carrying system;
floating at least one flotation system, having at least one floating element, on the surface of the body of water and supporting the submerged biomass-carrying system and water aeration device from totally submerging into the body of water.

17. The method of claim 16, whereby the biomass-carrying system and the aeration device are connected to the same flotation system.

18. The method of claim 16, whereby the biomass-carrying system and aeration device are connected to separate flotation systems.

19. The method of claim 18, whereby the separate flotation systems are reversibly connected by a mechanical connection fixture.

20. The method of claim 16, whereby the aeration device is an agitation device.
